(19) United States
(12) Patent Application Publication
(10) Pub. No.: US 2007/0078889 A1
(43) Pub. Date: Apr. 5, 2007

(54) Method and system for automated knowledge extraction and organization

(76) Inventor: Ronald Andrew Hoskinson, Oak Hill, VA (US)

Correspondence Address: ARENT FOX PLLC, 1050 CONNECTICUT AVENUE, N.W., SUITE 400, WASHINGTON, DC, 20036, US

(21) Appl. No.: 11/540,628

(22) Filed: Oct. 2, 2006

Related U.S. Application Data
(60) Provisional application No. 60/723,341, filed on Oct. 4, 2005.

(51) Int. Cl. G06F 7/00

(52) U.S. Cl. 707/102

(57) ABSTRACT

A method and system for automated knowledge extraction and organization, which uses information retrieval services to identify text documents related to a specific topic, to identify and extract trends and patterns from the identified documents, and to transform those trends and patterns into an understandable, useful and organized information resource. An information extraction engine extracts concepts and associated text passages from the identified text documents. A clustering engine organizes the most significant concepts in a hierarchical taxonomy. A hypertext knowledge base generator generates a knowledge base by organizing the extracted concepts and associated text passages according to the hierarchical taxonomy.

### CROSS-REFERENCE TO RELATED APPLICATIONS

This application claims priority of U.S. Provisional Patent Application Ser. No. 60/723,341, entitled METHOD AND SYSTEM FOR AUTOMATED KNOWLEDGE EXTRACTION AND ORGANIZATION, filed Oct. 4, 2005. The contents of this provisional application are hereby incorporated by reference in their entirety.

### BACKGROUND OF THE INVENTION

1. Field of the Invention

The present invention relates to a method and system for automated knowledge extraction and organization. The method and system of the present invention leverage existing search engine technology and various text-mining techniques to discover and extract relevant information concerning a particular subject area or topic from text documents found in large, distributed collections of information resources, such as the Internet. The method and system of the present invention further organize such information into a logical hierarchy of subtopics and publish the information to a hypertext knowledge base. The present invention extends the capabilities of existing search engines by automating many of the secondary analysis and aggregation tasks currently performed manually by knowledge workers when researching a complex subject using large collections of unstructured text information resources, such as the Internet.

2. Description of the Related Art

There exist in the art search engines for conducting research on large collections of unstructured text information resources, such as the Internet. One downside of these search engines is that in addition to performing the actual research, they often require a significant amount of additional efforts, especially when used to investigate complex topics. These additional efforts include analyzing search results, extracting and compiling relevant information, performing related searches, and organizing the results to provide the appropriate context for the topic at hand. Furthermore, many of these tasks are not automated, resulting in a laborious, time consuming research process. There exists a need in the art, therefore, to provide automation for these additional or secondary research tasks.

There exist in the art text-mining techniques, which may be used to automate many of the secondary research tasks. However, such text-mining techniques are currently not used in combination with commercially available Internet search technology to automate the aforementioned secondary research tasks. There exists a need in the art, therefore, to automate the extraction and organization of the knowledge buried in the research results, which may include hundreds or thousands of relevant pages returned by the typical search engine. Moreover, there is a further need in the art to combine commercially available Internet search technology with various text-mining techniques to assist with the creation of knowledge bases, encyclopedias, topic maps, and other knowledge organization systems.

### SUMMARY OF THE INVENTION

The present invention satisfies the above-identified needs, as well as others, by providing an open architecture comprising four major components: a Search Engine Client, an Information Extraction Engine, a Clustering Engine, and a Hypertext Knowledge Base Generator. The method and system of the present invention use these four major components to leverage commercially available web search services (interchangeably referred to herein as information retrieval services) to identify text documents related to a specific topic, to identify and extract trends and patterns from the identified documents, and to transform those trends and patterns into an understandable, useful, and well-organized information resource. Each of these four basic components is briefly described below.

In one embodiment, the first component, the Search Engine Client, provides a list of relevant documents using existing commercially available search services. This component uses a commercial search engine (such as Google or Yahoo) to provide the results of the research, usually comprising a list of relevant document Uniform Research Locators (URLs), alternatively referred to herein as “document corpus,” “corpus” or “search engine result set,” which may be forwarded to the information extraction engine for further processing. It will be understood by those of ordinary skill in the art, however, that other means of developing the initial document corpus may be used. Examples include a web spider that crawls through a web site by following hyperlinks in web pages, or a component that crawls recursively through computer file systems, web “bookmarks” captured with a web browser or bookmarking service, or a component that enumerates through result sets returned by a relational database management system.

The second component, the Information Extraction Engine, in one embodiment, extracts concepts and associated text passages from documents found by the search engine client. The information extraction engine mines both concepts and related text summaries from the document corpus represented by the search engine result set.

In one embodiment, the third component, the Clustering Engine, organizes the most significant concepts into a hierarchical taxonomy. The clustering engine may generate a taxonomy using the concepts harvested by the information extraction engine, thereby providing a “sitemap” that enables users to navigate through the hypertext knowledge base, created by the fourth component, the Hypertext Knowledge Base Generator, discussed in more detail below. One embodiment of the Clustering Engine employs a top-down, “divisive” clustering approach to generate the taxonomy. In this embodiment, the Clustering Engine populates the initial cluster (i.e., subset of a data set sharing a common trait, such as similarity) with a subset of the most relevant concepts, sorted in, e.g., descending order by document frequency and/or term frequency, and clusters the remainder recursively around the subset of the most relevant concepts. “Recursion” refers to a process where a method or procedure invokes itself, i.e. one of the steps of the procedure involves running the entire same procedure.

In another embodiment, the Clustering Engine uses a technique known as “agglomerative clustering,” which builds a taxonomy from, e.g., the bottom-up. In this approach, each concept is initially its own cluster. The clustering engine iteratively combines clusters based on a similarity algorithm until the taxonomy tree is built from bottom up. Similarity algorithms include, for example, document co-occurrence, term frequency, or Term Frequency-Inverse Document Frequency (TF-IDF). TF-IDF is a similarity algorithm well-known in the art for adjusting the statistical weight of a term's frequency by the number of overall occurrences of the term in the document corpus as a whole.

The Hypertext Knowledge Base Generator produces a hypertext knowledge base or other repository of data from the extracted concepts and text passages, organized using the taxonomy created by the clustering engine. It builds a hypertext knowledge base from the database populated by the remaining three major components. In one embodiment, the hypertext knowledge base generation component may store its output in HTML format. Alternatively, other markup languages or hypertext systems may be used. In other embodiments, the present invention can publish its hypertext knowledge bases to networked information systems such as metadata registries, web content management systems and portals, wikis, social bookmarking services such as del.icio.us, and computer drives, among other data repositories.

Other objects, features, and advantages will be apparent to persons of ordinary skill in the art from the following detailed description of the invention and the accompanying drawings.

### BRIEF DESCRIPTION OF THE DRAWINGS

FIG. 1 shows an embodiment of the method for automated knowledge extraction and organization of the present invention.

FIG. 2 shows an embodiment illustrating the operation of the search engine client in conjunction with an embodiment of the present invention.

FIG. 3A shows an embodiment illustrating the operation of the information extraction engine in conjunction with an embodiment of the present invention.

FIG. 3B shows an exemplary method used by the Information Extraction Engine to extract text from documents developed using World Wide Web Consortium (W3C)—style markup languages in conjunction with an embodiment of the present invention.

FIG. 3C shows an exemplary method for keyword extraction, used by the Information Extraction Engine in conjunction with an embodiment of the present invention.

FIG. 3D shows an exemplary method for phrase extraction, used by the Information Extraction Engine in conjunction with an embodiment of the present invention.

FIG. 3E shows an embodiment of the method for summarizing text. The information extraction engine uses this procedure, in conjunction with an embodiment of the present invention, to extract a text summary from the document, tied to a specific concept.

FIG. 4A shows an embodiment illustrating the operation of the clustering engine, used in conjunction with an embodiment of the present invention to generate a taxonomy of concepts to facilitate hypertext knowledge base organization.

FIG. 4B shows an exemplary method for taxonomy generation, used by the clustering engine in conjunction with an embodiment of the present invention to build the actual taxonomy.

FIG. 4C shows an exemplary method for concept clustering, used by the exemplary method for taxonomy generation in conjunction with an embodiment of the present invention to cluster an array of concepts based on document co-occurrence.

FIG. 5A shows an exemplary method for hypertext knowledge base generation, used in conjunction with an embodiment of the present invention to generate a hypertext knowledge base from the extracted concepts and text passages, organized using the taxonomy created by the clustering engine.

FIG. 5B shows an exemplary method for default page generation, used by the exemplary method for hypertext knowledge base generation in conjunction with an embodiment of the present invention to generate the hypertext knowledge base's default page (also known as “home page”).

FIG. 6A describes the user interface for an embodiment of the method for automated knowledge extraction and organization of the present invention.

FIG. 6B shows the default page of a sample hypertext knowledge base generated by an embodiment of the method for automated knowledge extraction and organization of the present invention.

FIG. 6C shows a topic page of a sample hypertext knowledge base generated by an embodiment of the method for automated knowledge extraction and organization of the present invention.

FIG. 6D shows a sample “directed graph” visualization of a taxonomy produced by an embodiment of the method for automated knowledge extraction and organization of the present invention.

FIG. 6E shows a sample “bar chart” visualization of a concept array produced by an embodiment of the method for automated knowledge extraction and organization of the present invention.

FIG. 6F shows a sample “topic cloud” visualization of a concept array produced by an embodiment of the method for automated knowledge extraction and organization of the present invention.

FIG. 7A describes an embodiment of the data model defining the structure of the database used by an embodiment of the method for automated knowledge extraction and organization of the present invention.

FIG. 7B shows a sample data structure returned by a database query retrieving top concepts, sorted in descending order by document frequency.

FIG. 8 presents an exemplary system diagram of various hardware components and other features, for use in accordance with an embodiment of the present invention;

FIG. 9 is a block diagram of various exemplary system components, in accordance with an embodiment of the present invention.

### DETAILED DESCRIPTIONS OF THE PREFERRED EMBODIMENTS

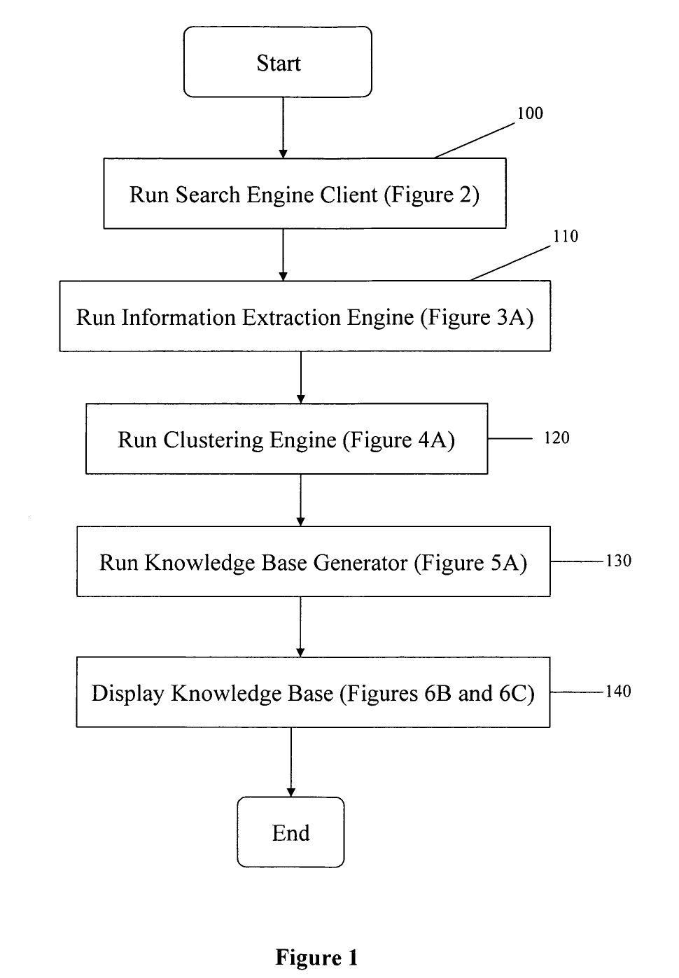

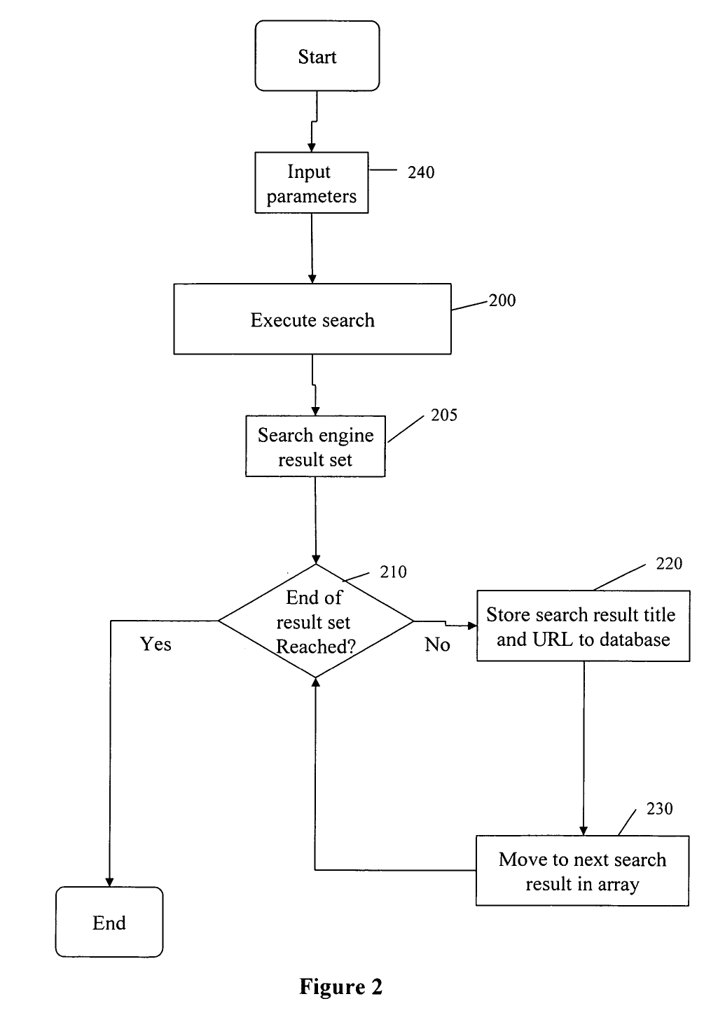

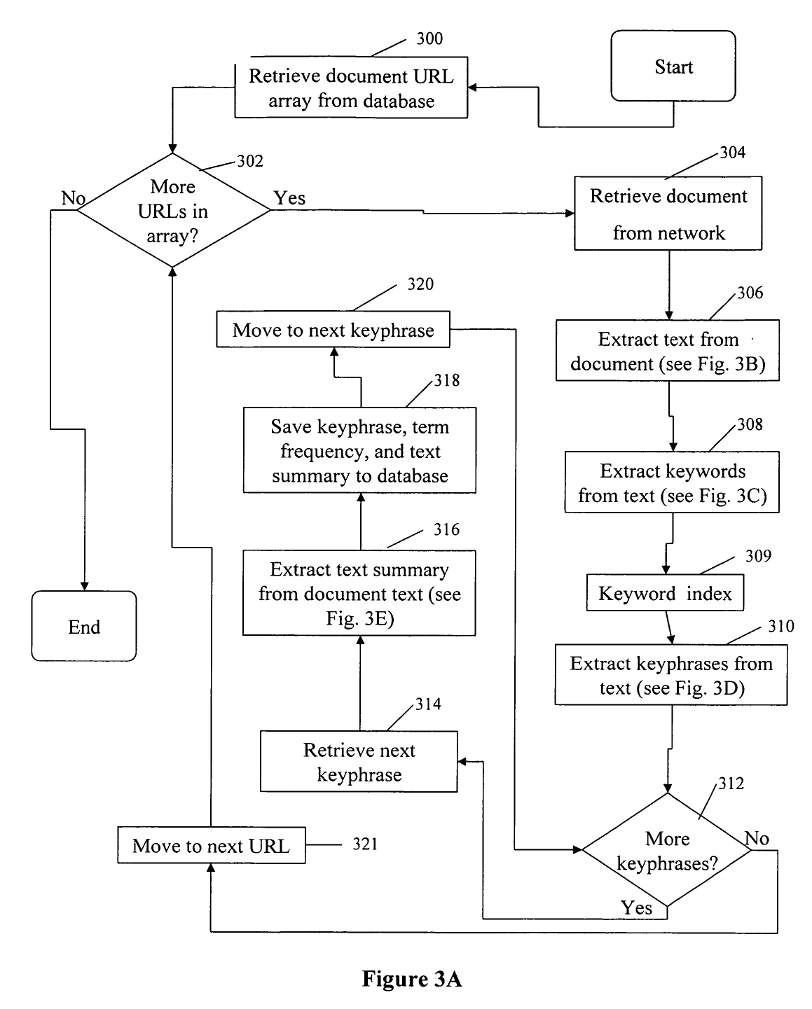

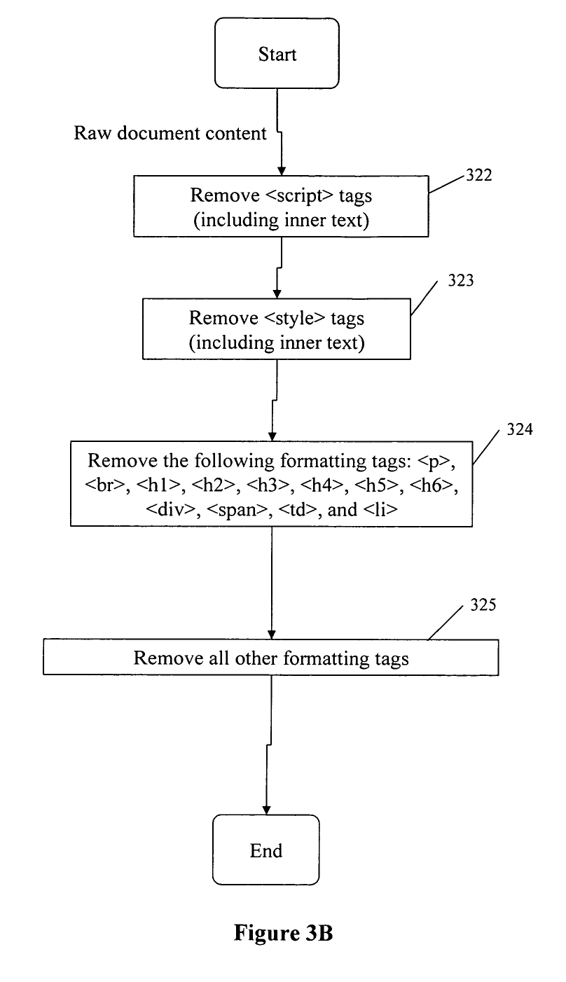

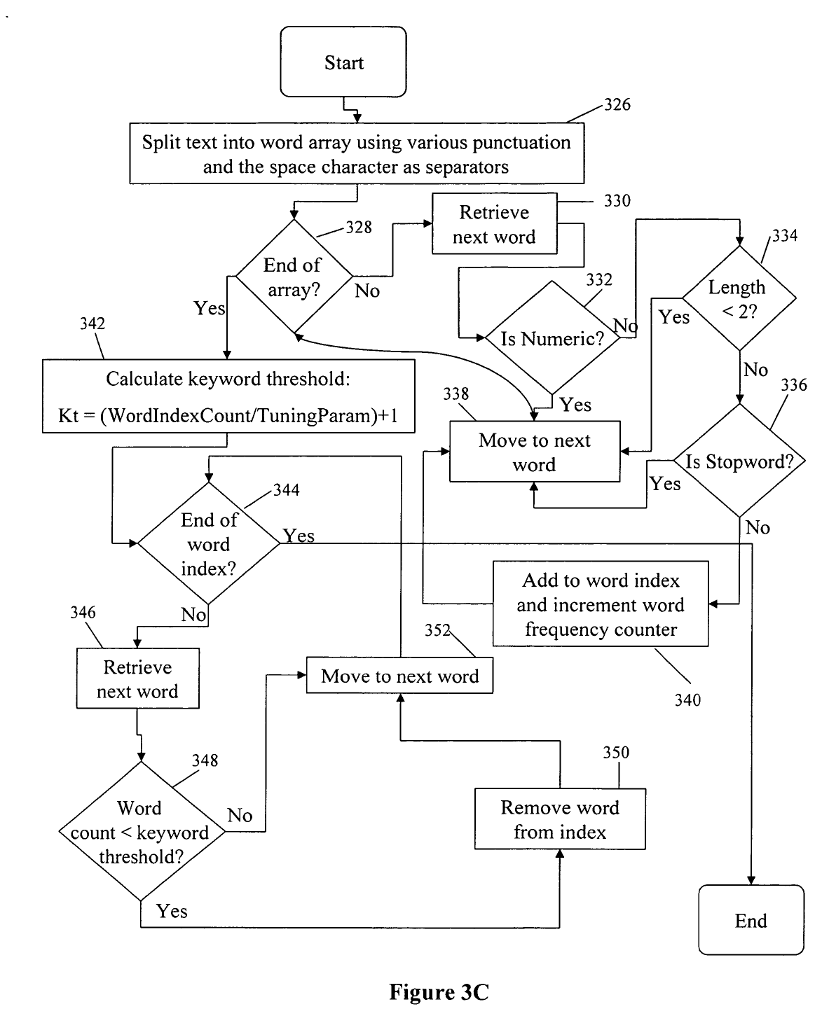

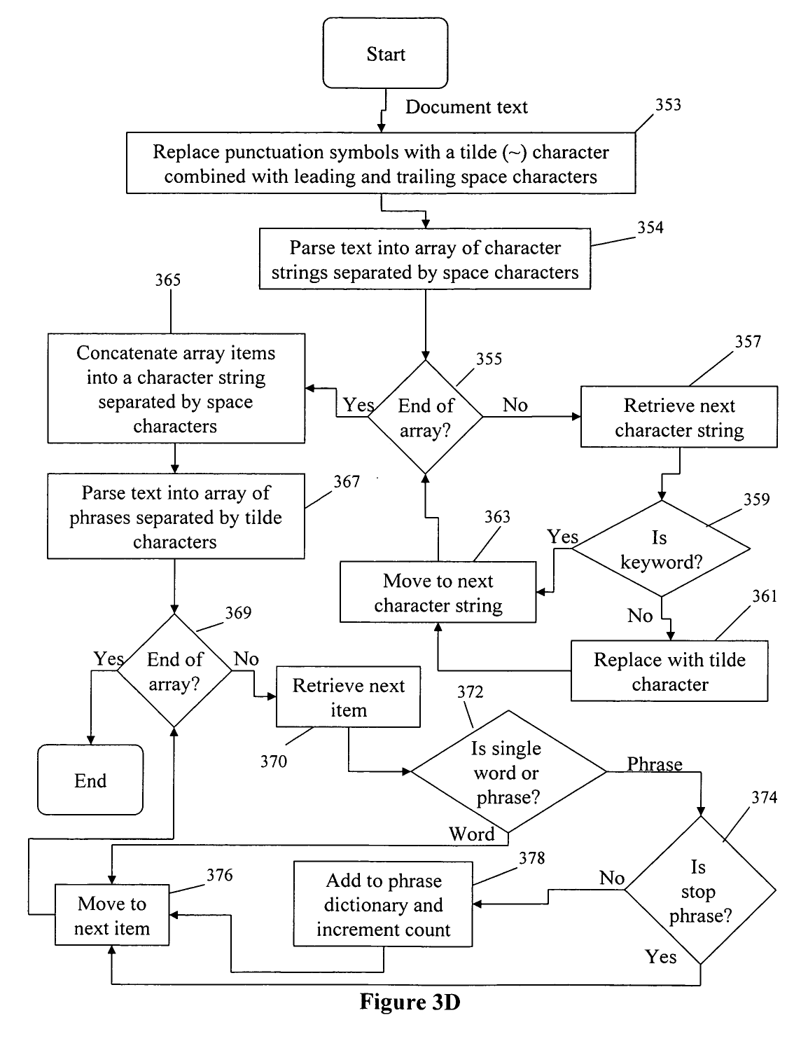

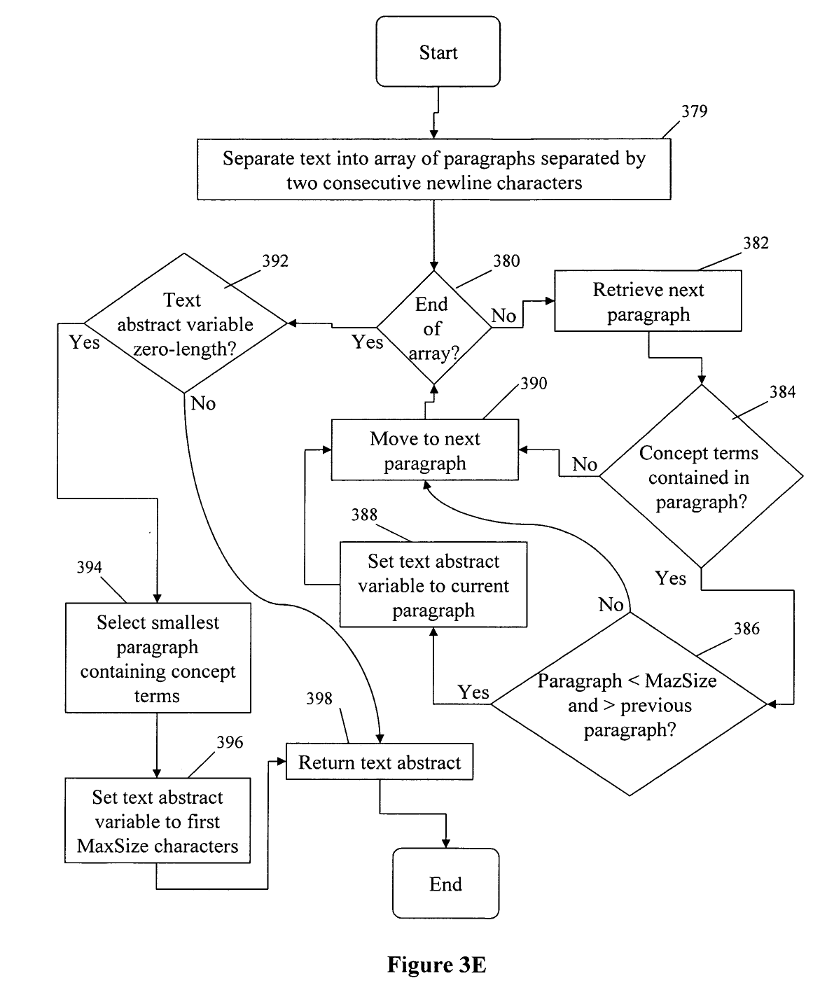

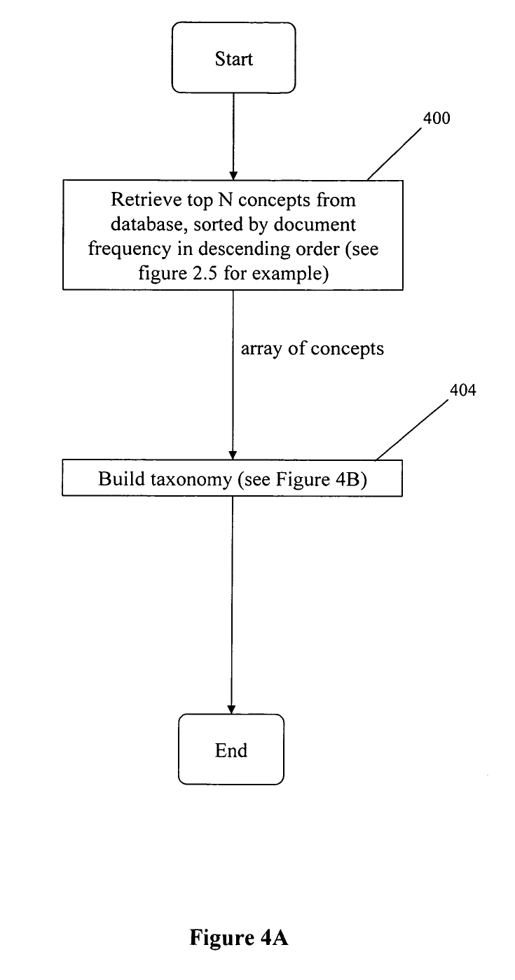

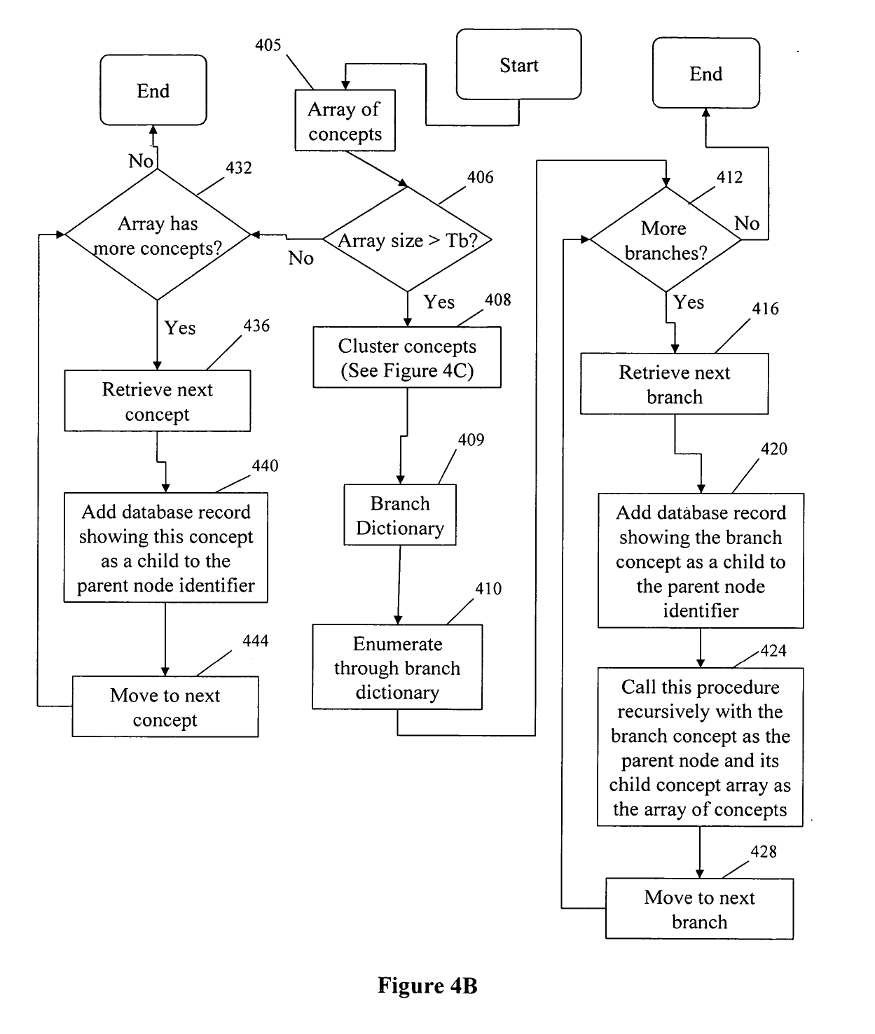

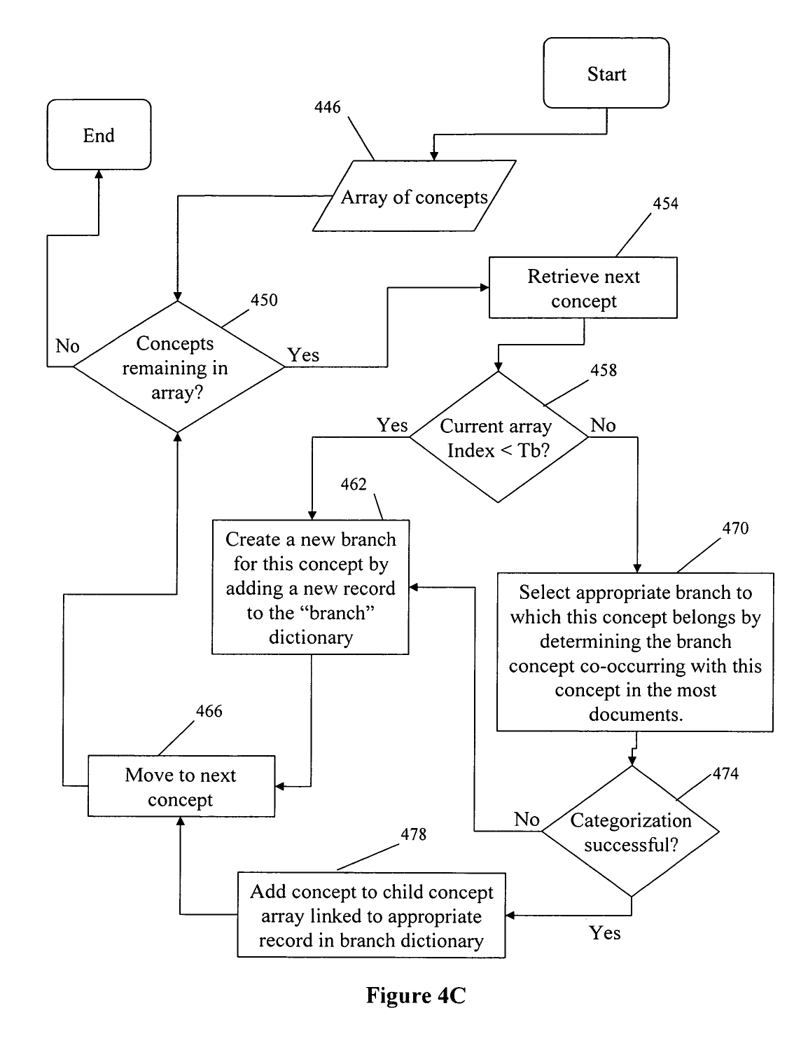

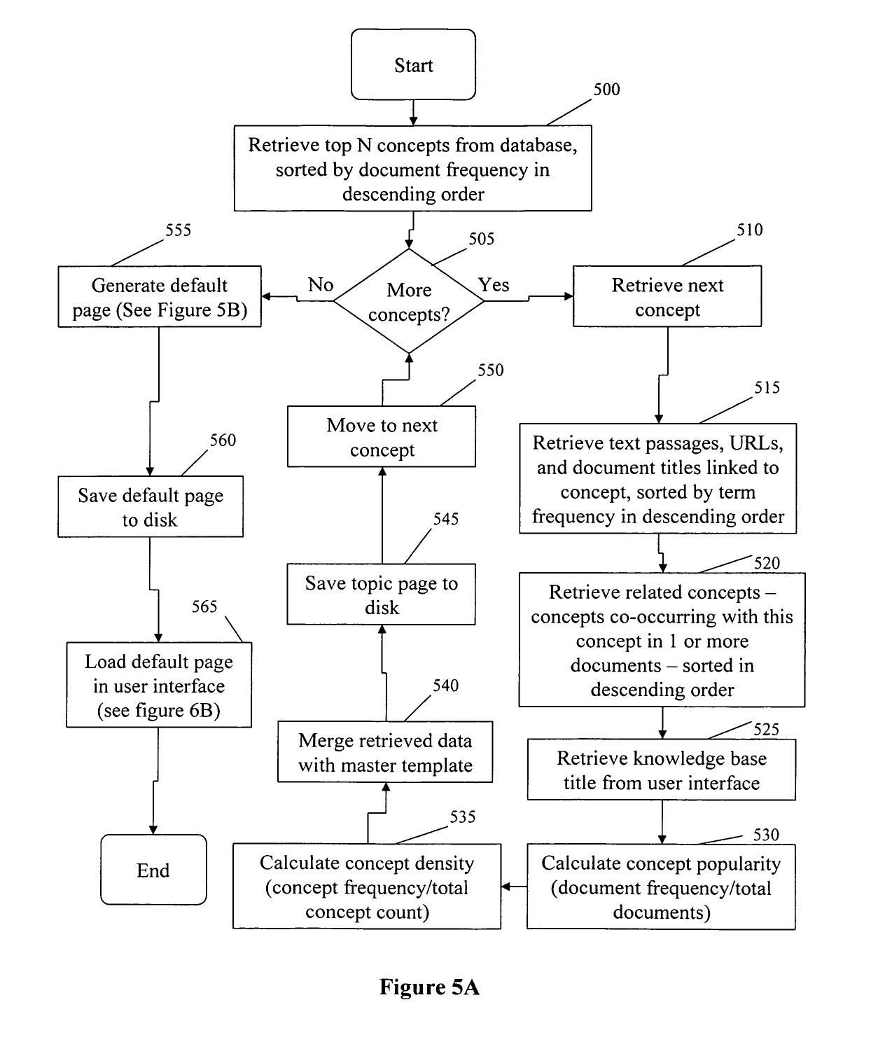

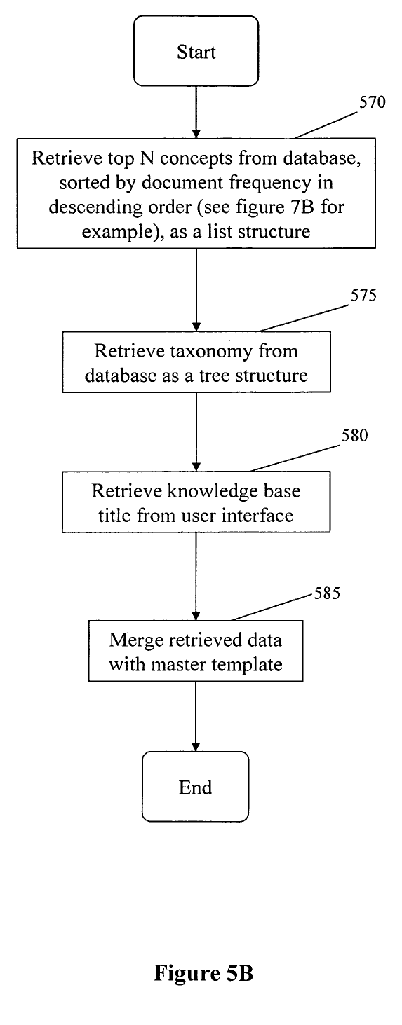

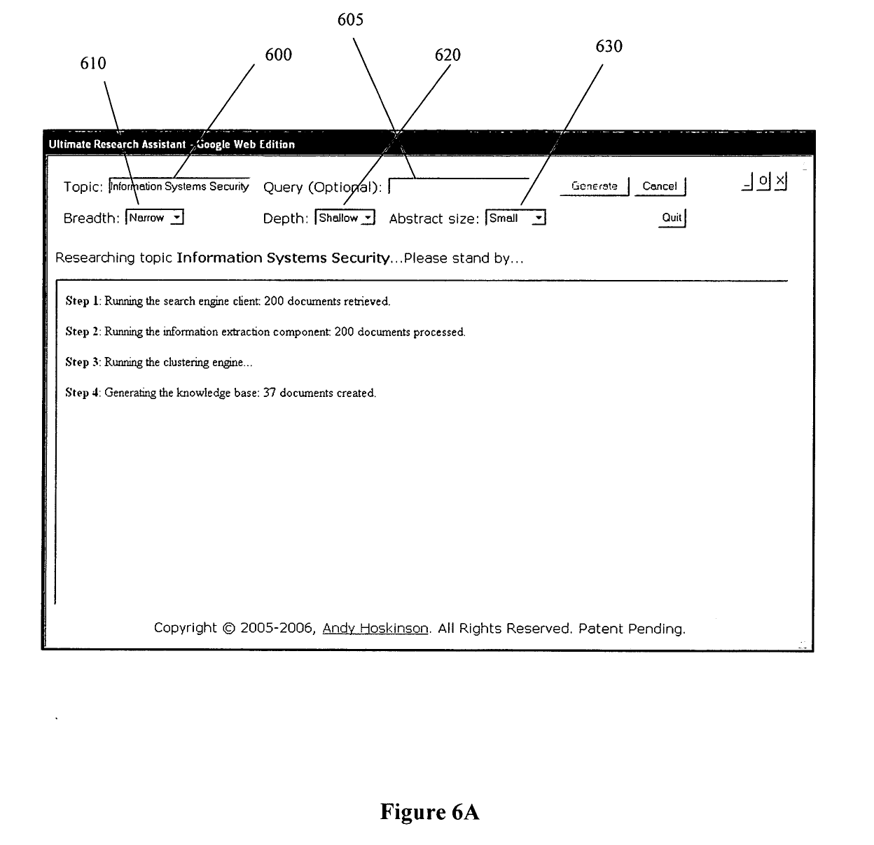

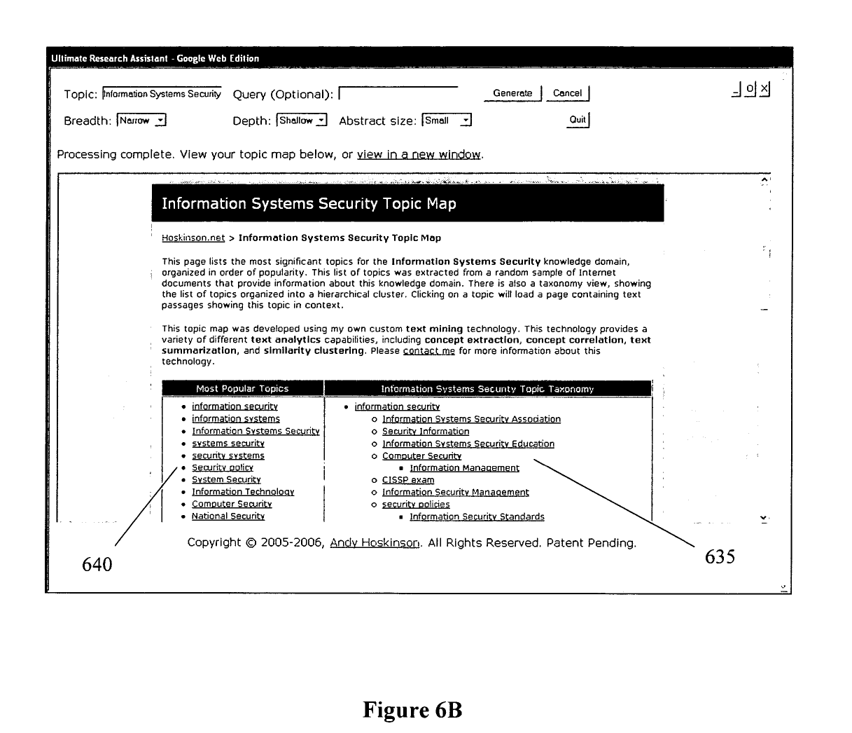

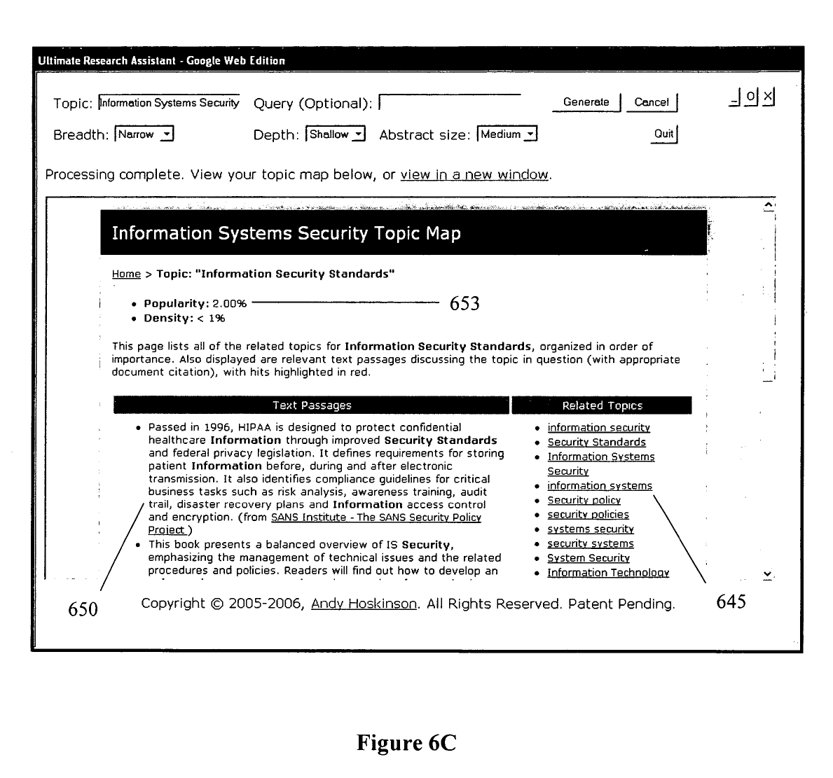

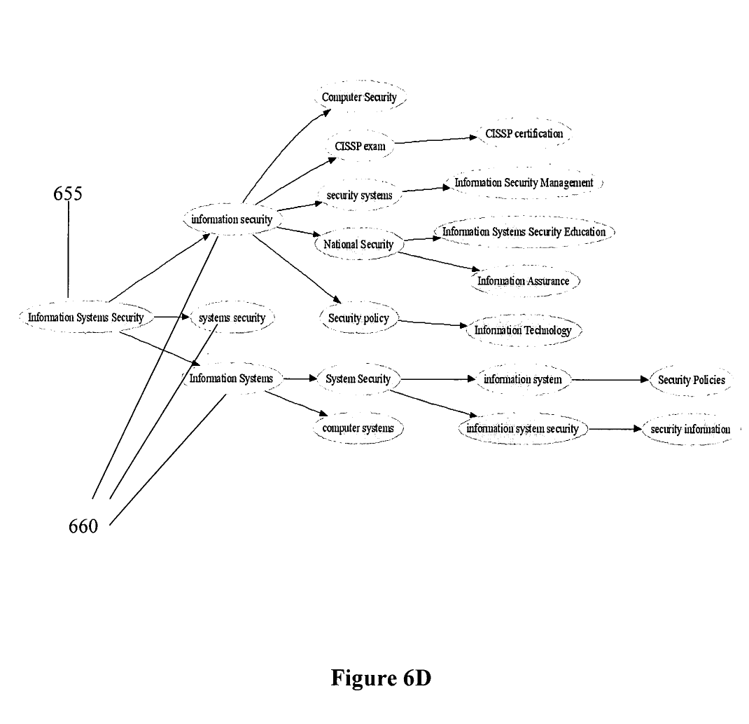

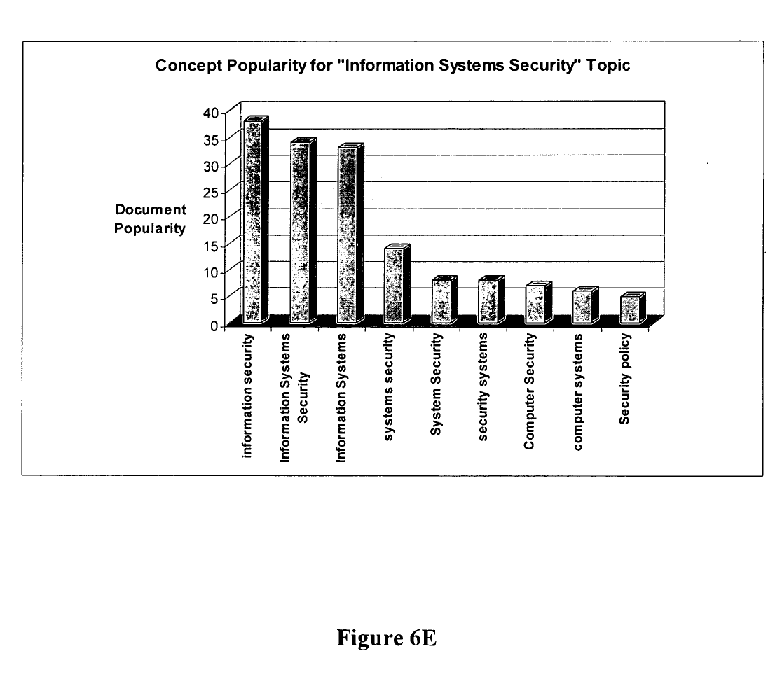

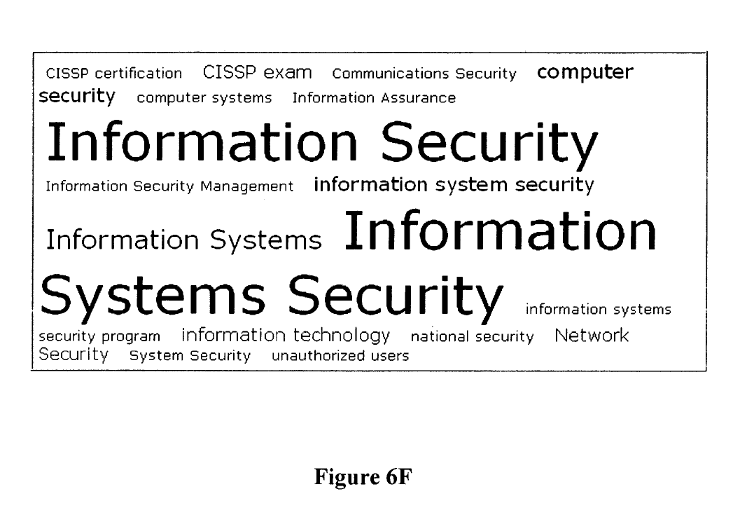

Referring now to FIG. 1, therein shown is one embodiment of the method for automated knowledge extraction and organization of the present invention. In step 100, the search engine client is invoked. Step 100 is further described below, and shown in more detail in the flowchart in FIG. 2. In step 110, the information extraction engine is run. Step 110 is further described below, and shown in more detail in the flowchart in FIG. 3A. In step 120, the clustering engine is invoked. Step 120 is further described below, and shown in more detail in the flowchart in FIG. 4A. In step 130, the hypertext knowledge base generator is invoked. Step 130 is further described below, and shown in more detail in the flowchart in FIG. 5A. In step 140, the completed hypertext knowledge base is displayed, as shown in FIGS. 6B and 6C.

Referring now to FIG. 2, therein shown is one technique that may be used by the invention to derive the list of information resources comprising the document corpus from which knowledge is extracted and organized. At step 240, several input parameters may be input into the Search Engine Client 200. These parameters may include, for example, a search engine and a maximum number of results for the search engine to return. These parameters are described in more detail below, in conjunction with the description of FIG. 6A.

In one embodiment, the system of the present invention may compute the maximum number of results for the search engine to return using formula (1) below.
N=<breadth>*10 (1)

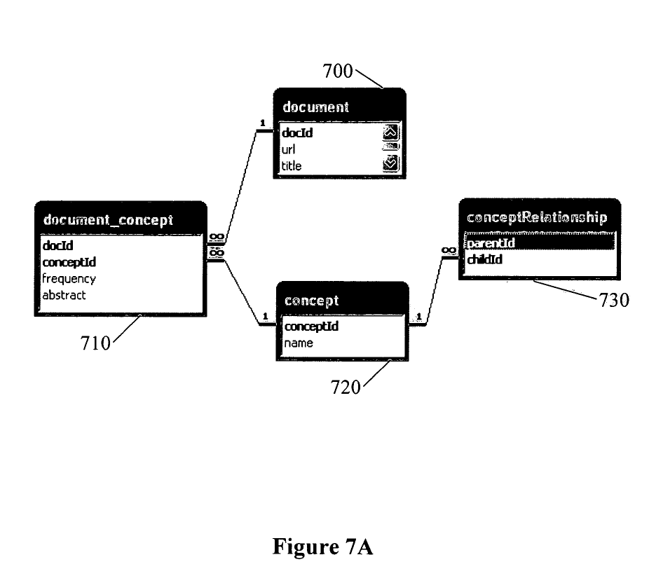

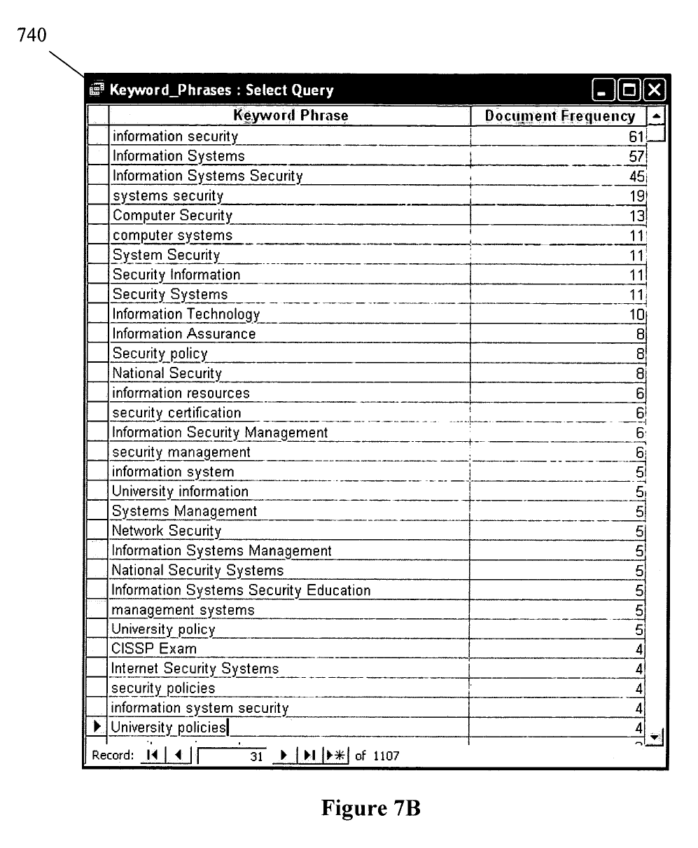

In formula (1), <breadth> is a variable that can be obtained from the user through the user interface described in more detail below in FIG. 6A. In one embodiment, this interface gives the user three choices: Narrow (assigning the breadth variable to, e.g., 20), Medium (assigning the breadth variable to, e.g., 40), and Broad (assigning the breadth variable to, e.g., 60). In other embodiments, the value of the <breadth> variable may be obtained through other means, for example as a system constant. The third input parameter is the connection string to the database in which results will be stored. This is typically stored as a system constant, or may be captured through the user interface in other embodiments. In one embodiment, the database implements a data model such as the one described in more detail below, in reference to FIG. 7A.

At step 200, the search engine client invokes the external search service and executes a search. This is usually accomplished through an application programming interface (API) published by the provider of the search service, but can also be accomplished through HTTP GET or POST. This operation returns a search engine result set 205 containing, at a minimum, a list, array, vector, or dictionary of information resources (such as web documents) matching the search terms provided. Each result set row typically includes, at a minimum, a pointer to the location of the information resource on a computer system or network in the form of a World Wide Web Consortium (W3C) Uniform Resource Locator (URL), and a descriptive title for the resource.

Next, the search engine client begins enumeration through the result set. If the end of the result set has not been reached 210, the search engine client stores the information resource title and URL to, e.g., database 220. In one embodiment of the invention, this information is stored in the “Document” data table, described in more detail below, in conjunction with the description of FIG. 7A. At step 230, the search engine client moves to the next search result in the result set 230, and repeats steps 210, 220, and 230 until the end of the result set has been reached. Once the end has been reached, the search engine client terminates.

Referring now to FIG. 3A, therein shown is one technique that may be used by the invention to extract keyphrases and associated text abstracts from documents harvested by the search engine client described earlier. In step 300, the information extraction engine queries the database and retrieves a document Uniform Resource Locator (URL) array from the document data table described in more detail below, in conjunction with the description of FIG. 7A. URL is a W3C standard for identifying the location of an information resource (e.g., document) on a computer system or network.

The information extraction engine then enumerates through the array. For each URL contained in the array 302, the information extraction engine retrieves a document from the network location specified by the URL 304, extracts text from the document 306, and extracts keywords from the document text 308, returning a keyword index 309. The operation “extract text from document” can be an external call to a component implementing a text extraction routine for a given file format. An embodiment of the method for automated knowledge extraction and organization of the present invention has a module, described in FIG. 3B, that extracts text from documents formatted using various W3C markup languages.

Using the keyword index 309 as an input, the information extraction engine then extracts keyphrases from the document text 310. This operation is further described in more detail in FIG. 3D. The terms “keyphrases” and “concepts” are used synonymously herein.

The information extraction engine then enumerates through the keyphrase array. For each keyphrase contained in the array 312, the information extraction engine retrieves the next keyphrase 314, and extracts a text summary, customized for each keyphrase, from the document text 316. This operation is described in further detail in conjunction with an embodiment shown in FIG. 3E.

In step 318, the information extraction engine saves the keyphrase, the term frequency, and the associated text summary to the database. Term frequency is the number of occurrences of a given keyphrase (concept) in a given document. The keyphrase is stored in the “Concept” table. Term frequency and text summary are stored in the “document_concept” table, along with pointers to the associated concept (keyphrase) and document. Both tables are described in more detail below, in conjunction with the description of FIG. 7A. In step 320, the information extraction engine moves to the next keyphrase in the array. If there are no more keyphrases 312, it moves to the next URL in the URL array 321. If there are no more URLs 302, the information extraction engine exits. [0045] As described above, in step 306, the information extraction engine extracts text from a document. Referring now to FIG. 3B, therein shown is one technique that may be used by one embodiment of the present invention to extract text from documents developed using W3C—style markup languages (e.g., HTML, XML, and XHTML).

The method shown in FIG. 3B processes the raw content of the document, extracts all text, and returns the document text to the calling information extraction engine. In step 322, all occurrences of the <script> tag in the document, including all inner text of the <script> tag, are replaced with a single newline character. “Newline character” denotes a character marking the end of a line of data and the start of a new line.

In step 323, all occurrences of the <style> tag in the document are replaced to include its inner text with a single newline character. In step 324, certain formatting tags (opening and closing tags only, not the inner text) are each replaced with two consecutive newline characters. These tags may include the <p>, <br>, <h1>, <h2>, <h3>, <h4>, <h5>, <h6>, <div>, <span>, <td>, and <li> tags. In step 325, all other formatting tags (all text between the <and> characters, inclusive) are replaced with one newline character. At this point, the procedure is complete.

As described in step 308 in reference to FIG. 3A, the information extraction engine extracts keywords from the text of the document. Referring now to FIG. 3C, therein shown is one technique that may be used by one embodiment of the present invention to select only those words in the document that are considered “key”, i.e. significant in determining meaning of the document as a whole. Using the method shown in FIG. 3C, the document text is taken as an input, and an index of keywords is returned as an output.

In step 326, the document text is split into a word array using various punctuation characters and the space character as separators. In this embodiment, the punctuation characters used to create the initial word array may include the @ character, period (.), comma (,), semi-colon (;), colon (:), parentheses (( )), the back-slash character (\), the forward slash character (/), asterisk (*), ampersand (&), brackets ({ } and [ ]), question mark (?), exclamation mark (!), the equal character (=), quote characters (“ ”), copyright characters (© ®), the addition operator (+), the pound sign (#), the underscore character (_), the double-dash (--), angular brackets (< and >), the pipe character (|), and non-printing characters such as the carriage return, newline, tab, formfeed, and linefeed characters. For each element in the array 326, the procedure retrieves the next available word in the array 330, until the end of the array is reached 328.

Upon retrieving each element in the array 330, a check for stopwords is performed and an initial word index is built. Stopwords are common words (e.g., and, or, the, an, etc.) that add little or no value to the subject matter of a given document. A “word index” is a dictionary of words occurring in a document, with the number of times each word occurs (e.g., the “word count”) in the document. A dictionary is a type of data structure, and is alternatively referred to herein as an “associative array” or “lookup table.” If the current retrieved word in the word array enumeration is not a numeric value 332, has 2 or more characters 334, and is not a stopword 336, the retrieved word is added to the word index and the word frequency counter is incremented by one 340. Otherwise, the retrieved word is disregarded, and the procedure moves to the next word in the array 338.

In one embodiment, upon reaching the end of the array 328, words from the word index that are “non-key” are removed. In step 342, the exemplary method for keyword extraction calculates the keyword threshold Kt using formula (2) below.
Kt=(WordIndexCount/TuningParam)+1 (2)

In formula (2), WordIndexCount is the number of unique terms occurring in the document, minus stopwords. In one embodiment, the value of TuningParam may be obtained through the user interface, described in more detail below in conjunction with FIG. 6A, specifically a “Depth” parameter 620, shown in FIG. 6A. In one embodiment, the assigned depth values may be, e.g., 50 for “Shallow,” 100 for “Medium,” and 150 for “Deep.” In other embodiments, the value of this variable may be obtained through other means, for example as a system constant.

Referring again to FIG. 3C, upon calculating the keyword threshold Kt 342, an enumeration through the word index is performed 344. For each word in the word index, the word count is compared 348 with the keyword threshold calculated in step 342. If the word count is less than the keyword threshold 348, the word and its associated word count is removed from the word index 350. Otherwise, the word is retained in the word index. When this enumeration is complete 344, the modified word index (containing keywords only) is returned to the calling component.

As described in step 310 in reference to FIG. 3A, the information extraction engine extracts keyphrases from the text of the document in question. Referring now to FIG. 3D, therein shown is one technique that may be used by one embodiment of the present invention to select only those phrases in the document that are considered “key,” i.e., significant, in determining the meaning of the document as a whole. The exemplary method for keyphrase, or concept, extraction takes as its input the document text and keyword index, and returns a dictionary of keyphrases, or concepts, as its output.

In step 353, the document text is analyzed and certain punctuation symbols associated with delineating phrase boundaries are replaced with, e.g., a tilde (˜) character combined with leading and trailing space characters (i.e., the character string “˜”). These punctuation characters may include the @ character, period (.), comma (,), semi-colon (;), colon (:), parentheses (( )), the back-slash character (\), the forward slash character (/), asterisk (*), ampersand (&), brackets ({ } and [ ]), question mark (?), exclamation mark (!), the equal character (=), quote characters (“ ”), copyright characters (© ®), the addition operator (+), the pound sign (#), the underscore character (_) the double-dash (--), angular brackets (< and >), the pipe character (|), and non-printing characters such as the carriage return, newline, tab, formfeed, and linefeed characters, among others. In one embodiment, the tilde character (˜) is used as a phrase boundary marker because it is used extremely infrequently in text content. Other characters can be substituted if desired when implementing this invention. In step 354, the exemplary method for phrase extraction parses the text of the document into an array of character strings separated by space characters. This creates an array containing items that are either individual words or phrase boundary characters (e.g., the above-referenced tilde characters).

Next, the exemplary method for phrase extraction enumerates through the character array. For each item in the array, the next character string is retrieved 357 and a determination is made whether it is a keyword 359, using the keyword index provided to the phrase extractor as an input. If the retrieved character string is not a keyword 359, the phrase extractor replaces it with a phrase boundary character (e.g., a tilde character) 361. After that, the process is repeated for each next character string in the array 363, until the end of the array is reached 355. This ensures that only phrases combining keywords are included as keyphrases in the document.

Once the exemplary method for phrase extraction has reached the end of the array 355, the array items are concatenated into a character string separated by space characters 365, the character string is parsed into an array of phrases separated by, e.g., tilde characters 367. The resulting array is then enumerated 369, each next available item is retrieved 370, and a determination is made whether it is a single word or phrase 372. If the retrieved item is a single word, no action is taken, and the next item in the array is retrieved 376. If the retrieved at step 370 is a phrase (as opposed to a single word) and is not a “stop phrase” 374, it is added to the keyphrase dictionary, and the phrase count is incremented by one 378. The “keyphrase dictionary” is a dictionary of phrases occurring in a document and contains an indication of the number of times each phrase occurs (i.e., “phrase count”) in the document.

Similar to stop words, stop phrases add little or no value to the subject matter of a given document. These may include phrases such as “privacy policy” that are used frequently on web pages. In one embodiment of the present invention, stop phrases are added, as needed, to the system configuration file by either the system administrator or end user, and a check is performed for stop phrases 374. If the currently retrieved phrase is not a stop phrase, the phrase is added to the phrase dictionary, and the phrase count is increased 378. If it is a stop phrase, no action is taken, and the next item is retrieved 376. The process is repeated until the end of the array is reached 369. Once the exemplary method for phrase extraction has completed looping through the array 369, it exits, returning the keyphrase dictionary to the calling component. As described in step 316 in reference to FIG. 3A, the information extraction engine extracts a text summary from the document, tied to a specific keyphrase. Referring now to FIG. 3E, therein shown is one technique that may be used by one embodiment of the present invention to perform this operation. Extracting a text summary from the document tied to a specific keyphrase requires two inputs: the document text and a word or phrase. The output provided is a text summary of the document.

In step 379, the exemplary method for text summarization separates the document text into an array of paragraphs, using two consecutive newline characters as a paragraph boundary. The resulting array is then enumerated 380. For each retrieved paragraph in the array 382, a check is performed to ensure that the term or phrase is contained in the paragraph 384. If so, the length of the paragraph is checked to determine whether it is less than the MaxSize variable and greater than the size of the previous paragraph in the array 386.

The MaxSize variable may be obtained from the user interface, described in more detail below, in conjunction with the description of FIG. 6A. The Abstract Size input control 630, for example, may have values as follows: Small=250, Medium=500, Large=1000. In other embodiments, the Abstract Size input control 630 variable may be obtained through other means, for example as a system constant.

Referring again to FIG. 3E, if both these conditions are met 386, the text abstract variable is set to the value of the current paragraph's text 388. The text abstract variable is a return value, and is initially set to a zero-length string. The next paragraph in the array is then retrieved 390.

If either of the conditions in step 386 is not met, the procedure takes no further action and moves to the next paragraph 390. This procedure is repeated until the end of the array is reached 380, upon which the value of the text abstract variable is examined 392. If this variable is still zero-length, the exemplary method for text summarization picks from the paragraph array the smallest paragraph in the document containing the concept terms 394, and sets the text abstract variable to the first MaxSize characters of the smallest paragraph 396. Otherwise, the exemplary method for text summarization returns the current value of the text abstract variable as the text summary 398.

Referring now to FIG. 4A, therein shown is one technique that may be used by one embodiment of the present invention to generate a taxonomy of concepts or keyphrases for the hypertext knowledge base. In step 400, the clustering engine retrieves the top N concepts from the database, sorted by document frequency in descending order. This particular data structure is described in more detail below, in conjunction with the description of FIG. 7B. “Document frequency” refers to the number of documents in which a concept or keyphrase occurs at least once. It is a measure of popularity of a concept. The variable N is calculated using formula (3) below.
N=<breadth>*2 (3)

In one embodiment, the present invention obtains the value of the <breadth> variable from the user through the user interface described in more detail below, in conjunction with the description of FIG. 6A. For Breadth variable 610, shown in FIG. 6A, the initial choices may be set as follows: Narrow=20, Medium=40, Broad=60. In other embodiments, the value of this variable may be obtained through other means, for example as a system constant.

Referring again to FIG. 4A, the clustering engine then builds a taxonomy from the resulting array of concepts 404, using the procedure defined below in conjunction with the description of FIG. 4B. Taxonomy relationships derived from this step are stored in the concept Relationship table, described in more detail below in conjunction with the description of FIG. 7A.

In step 404 of FIG. 4A, the clustering engine invokes a taxonomy builder to build the actual taxonomy.

Referring now to FIG. 4B, therein shown is one technique that may be used in one embodiment of the present invention to build the taxonomy. The inputs for building a taxonomy are an array of concepts, input at step 405, and a pointer to a parent node identifier, which initially may be, e.g., the root node, and is described in more detail below, in conjunction with the description of FIG. 6D. The output of building the taxonomy is saved to, e.g., a database, such as the one described in more detail in conjunction with FIG. 7A. The taxonomy is a hierarchical ordering of the array of concepts passed in by the calling program.

In one embodiment, a programming environment with zero-based array indexing may be used. Taxonomy relationships may be stored in the conceptRelationship table, described in more detail below, in conjunction with the description of FIG. 7A.

The data structure used to store the taxonomy may be, e.g., a directed graph (see FIG. 6D) or “tree” structure with a root node 655 containing child nodes 660, which in turn may contain their own children, as shown in FIG. 6D.

Referring again to FIG. 4B, the taxonomy tree in one embodiment may be built from the top-down. An array of concepts is input 405, along with a pointer to the parent node for the concepts in this array (not shown). A null pointer indicates that some of these concepts might have as their parent the root node of the taxonomy. In this embodiment, the concepts or keyphrases are sorted by popularity (document frequency) in descending order when received.

In step 406, the taxonomy builder checks the size of the array against the value of the Tb variable. The variable Tb (Tb is an acronym for “taxonomy breadth”) is calculated using formula (4) below.
Tb=<breadth>/4 (4)

In one embodiment, the system of the present invention may obtain the <breadth> variable from the user through the user interface described in more detail below, in conjunction with the description of FIG. 6A, which may have, e.g., the following pre-set values: Narrow=20, Medium=40, Broad=60. In other embodiments, the value of this variable may be obtained through other means, for example as a system constant. If the array size is greater than Tb, the taxonomy builder clusters concepts in the array 408 using the procedure described below in conjunction with FIG. 4C. Upon clustering the concepts 408, a “branch dictionary” data structure is output 409, showing parent node/child node relationships.

In step 410, the taxonomy builder enumerates through the branch dictionary and, for each individual branch 416, adds a database record showing the branch concept as a child to the parent node identifier 420. In one embodiment, the taxonomy builder then performs a recursive call to build out the remainder of the taxonomy from the top down, passing the branch concept in as the parent concept and the branch concepts' children as the array of concepts 424. The taxonomy builder then moves to the next branch 428, and enumerates through the remainder of the branch dictionary until no more branches remain 412.

If the array size is less than or equal to the value of the Tb variable 406, the taxonomy builder checks to ensure the concept array has more members 432, and, if so, retrieves the next concept 436, adds a database record showing this concept as a child to the parent node identifier 440, and continues enumeration through the array 444 until no more members are left 432. The procedure then exits.

Referring now to FIG. 4C, therein shown is one technique that may be used by the invention to perform concept clustering, as described above in reference to FIG. 4B. Concept clustering takes as an input an array of concepts, input at 446. In one embodiment, concept clustering selects “branch” concepts from the input array to serve as parent nodes, and categorizes the remaining concepts in reference to the branch concepts using document co-occurrence as the similarity metric. In one embodiment, concepts are sorted by popularity (document frequency) in descending order when received by the concept clustering procedure. In one embodiment, a programming environment with zero-based array indexing is used.

The output of this procedure is a dictionary of “branch” concepts, each pointing to an array of child concepts. “Branch” in this context refers to the branch of the “tree” data structure used to store the taxonomy. For each concept in the array 446, the concept clustering procedure retrieves the next concept 454, and examines the concept array's current index against Tb variable 458. An array index is known to those skilled in the relevant art(s) as a numeric value specifying the location of an item in an array. The variable Tb (Tb is an acronym for “taxonomy breadth”) is calculated using formula (4), described above in conjunction with the description of FIG. 4B. If the concept array's current index is greater than or equal to the value of the Tb variable, the concept clustering procedure selects the appropriate branch to which this concept belongs by determining the branch concept co-occurring with this concept in the most documents 470. If the categorization is successful (i.e., a match is located) 474, the procedure adds the concept to the child concept array linked to the appropriate record in branch dictionary 478. Otherwise, it creates a new branch for this concept by adding a new record to the “branch” dictionary 462. This is also the action taken if the current array index is less than the value of the Tb variable 458. In step 466, the procedure moves to the next concept. If there are more concepts remaining in the array 450, the concept clustering procedure repeats the process, terminating when the entire array has been processed. The procedure returns the branch dictionary to its calling procedure upon termination.

Referring now to FIG. 5A, therein shown is one technique that may be used by one embodiment of the present invention to generate a hypertext knowledge base from the extracted concepts and text passages, organized using the taxonomy created by the clustering engine. In step 500, the hypertext knowledge base generator retrieves the top N concepts from the database, sorted by document frequency in descending order. The variable N is calculated using formula (3), described above in conjunction with the description of FIG. 4A. The hypertext knowledge base generator enumerates through the concept array. For each retrieved concept 510, the database is queried to retrieve text passages, URLs, and document titles linked to the concept, sorted by term frequency in descending order 515.

In step 520, the hypertext knowledge base generator retrieves related concepts, which are concepts co-occurring with this concept in one or more documents, and sorts them in descending order 520. At step 525, a hypertext knowledge base title may be obtained from the “Topic” input control 600 on the user interface, described in more detail in conjunction with FIG. 6A. In step 530, the hypertext knowledge base generator calculates concept popularity by dividing document frequency (the number of documents in which the concept occurs) by total documents in the database. In step 535, the hypertext knowledge base generator calculates concept density by dividing concept frequency (the number of total occurrences of this concept) by total concept count (the total number of occurrences of all concepts in the database).

In step 540, the hypertext knowledge base generator merges retrieved data with the master template. The “master template” defines the overall typography and page layout design for the hypertext knowledge base. It can be implemented using different techniques. The technique used in one embodiment is an extensible stylesheet language (XSL) stylesheet. Other embodiments may use other templating languages, methods, or procedures. The completed topic page is saved 545, and the next concept is retrieved 550. The process is repeated until all topic pages have been generated and there are no more concepts 505. In step 555, the default page is generated, which is described in more detail in conjunction with FIG. 5B. In step 560, the default page is saved. In one embodiment, the default page may be loaded into the user interface for display, described in more detail in reference to FIG. 6B.

Referring now to FIG. 5B, therein shown is one technique that may be used by one embodiment of the present invention for default page generation. In step 570, the default page generator retrieves the top N concepts from database, sorted by document frequency in descending order, as a list structure. The variable N is calculated using formula (3), described above in conjunction with FIG. 4A. In step 575, the default page generator retrieves the taxonomy created by the clustering engine from the database as a tree structure. For presentation purposes, all top-level nodes in the taxonomy without any children are grouped in a category called “Other Topics.” The hypertext knowledge base title may be obtained from the “Topic” input control on an embodiment of the user interface described in more detail in FIG. 6A below. In step 585, retrieved data are merged with a master template, implemented as an XSL stylesheet in one embodiment. A screenshot of a sample default page is shown in FIG. 6B.

Referring now to FIG. 6A, therein shown is one technique that may be used to implement a user interface for an embodiment of the method for automated knowledge extraction and organization of the present invention. Exemplary user interface elements include fields to type the topic name and 600 optionally a query (if different from the topic name) 605, an input control for selecting the breadth parameter 610, an input control for selecting the depth parameter 620, and an input control for selecting the abstract size 630. If the optional query field 605 is zero-length, an embodiment of the present invention uses the topic name itself 600 as the search engine query string. In one embodiment, the breadth parameter input control 610 is implemented as a drop-down widget, having preset choices, such as: Narrow=20, Medium=40, and Broad=60. In one embodiment, the depth parameter input control 620 may be implemented as a drop-down widget, having preset choices, such as: 50 for “Shallow,” 100 for “Medium,” and 150 for “Deep.” In one embodiment, the abstract size parameter input control 630 may implemented as a drop-down widget as well, having preset choices, such as: Small=250, Medium=500, Large=1000.

Referring now to FIG. 6B, therein shown is one example of a hypertext knowledge base that can be generated by an embodiment of the method for automated knowledge extraction and organization of the present invention—specifically, the sample default page. The default page may consist of two elements: a list of the most popular concepts (as measured by document frequency) 640, and a rendering of the taxonomy created by the clustering engine 635.

Referring now to FIG. 6C, therein shown is one example of a hypertext knowledge base that can be generated by an embodiment of the method for automated knowledge extraction and organization of the present invention—specifically, a sample topic page. In this context, the term “topic” is synonymous with the terms “concept” and “keyphrase.” Each topic page may consist of a listing of relevant text summaries with document citation 650, and a list of related concepts 645. Related concepts are concepts that co-occur frequently with the topic in question, sorted in descending order by document co-occurrence frequency. The related concept list provides visibility to implicit relationships that are potentially important, yet non-obvious, in the context of a given document corpus. The related concept list may also display popularity and density metrics 653 for the topic described on the topic page.

Referring now to FIG. 6D, therein shown is one example of a visualization of the taxonomy created by the clustering engine of an embodiment of the method for automated knowledge extraction and organization of the present invention. In this case, the taxonomy is visualized as a directed graph, with a root node 655 decomposing into child nodes 660.

Referring now to FIG. 6E, therein shown is one example of a visualization of the concepts extracted by the information extraction engine of an embodiment of the method for automated knowledge extraction and organization of the present invention. In this case, the concepts are visualized as a bar chart, showing relative concept popularity.

Referring now to FIG. 6F, therein shown is one example of a visualization of the concepts extracted by the information extraction engine of an embodiment of the method for automated knowledge extraction and organization of the present invention. In this case, the concepts are visualized as a “topic cloud.” This visualization technique is known to persons skilled in the art as a weighted visual depiction of topics or concepts showing relative concept popularity by displaying the more popular concepts with a larger font.

Referring now to FIG. 7A, therein shown is one embodiment of a data model describing a relational database that may be used by the invention for storage of information aggregated and produced by the invention's various methods. This embodiment shows four data tables: the document table 700, storing document URLs and titles; the concept table 720, storing concept (keyphrase) names; the document_concept table 710 establishing many-to-many relationships between documents and concepts and also storing context-sensitive text summaries; and the conceptRelationship table 730 storing the taxonomic relationships between concepts.

Referring now to FIG. 7B, therein shown is one example of a data structure used by an embodiment of the method for automated knowledge extraction and organization of the present invention. This data structure is the output of a database query retrieving top concepts, sorted in descending order by document frequency 740. This data structure can be used throughout the invention, especially by the clustering engine.

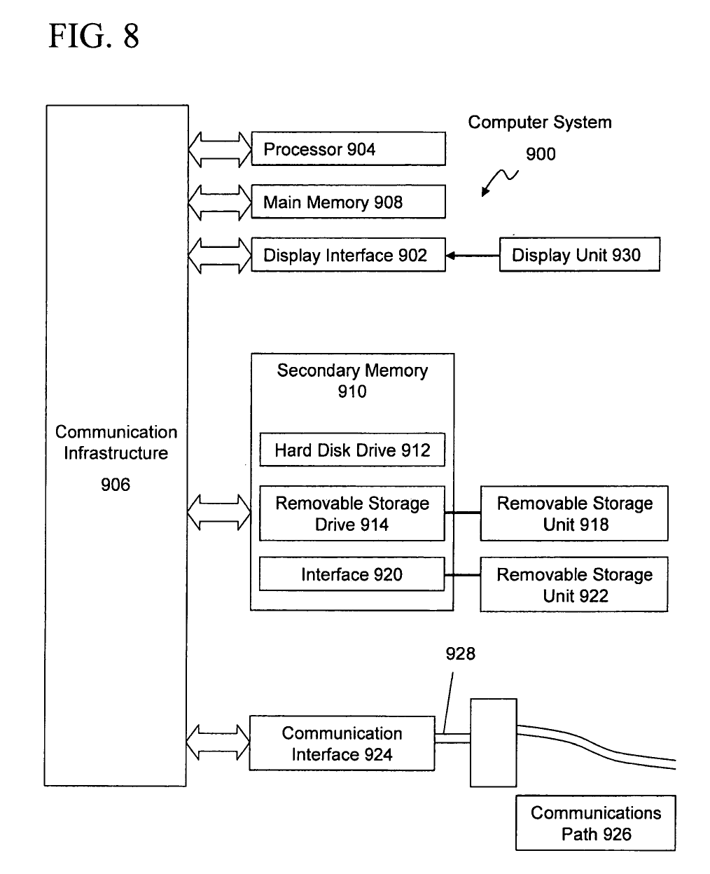

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system 900 is shown in FIG. 8.

Computer system 900 includes one or more processors, such as processor 904. The processor 904 is connected to a communication infrastructure 906 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative embodiments, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features of the present invention. Accordingly, such computer programs represent controllers of the computer system 900.

In an embodiment where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

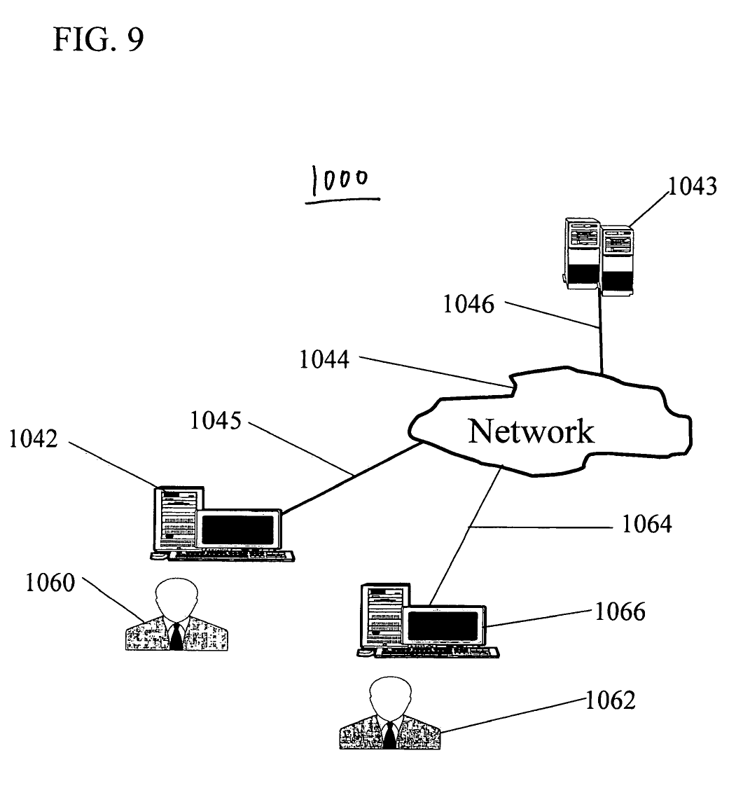

FIG. 9 shows a communication system 1000 usable in accordance with the present invention. The communication system 1000 includes one or more accessors 1060, 1062 (also referred to interchangeably herein as one or more “users”) and one or more terminals 1042,1066. In one embodiment, data for use in accordance with the present invention is, for example, input and/or accessed by accessors 1060,1064 via terminals 1042,1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a processor and/or repository for data, via, for example, a network 1044, such as the Internet or an intranet, and couplings 1045, 1046, 1064. The couplings 1045, 1046, 1064 include, for example, wired, wireless, or fiberoptic links. In another embodiment, the method and system of the present invention operate in a stand-alone environment, such as on a single terminal.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A method for automated knowledge extraction and organization, the method comprising:
providing a list of relevant documents resulting from a search of unstructured text information resources;
extracting concepts from the relevant documents;
organizing the extracted concepts in a taxonomy; and
building a knowledge base of the extracted concepts;
wherein the knowledge base is organized based on the taxonomy.

2. The method of claim 1, wherein extracting concepts from the relevant documents further comprises:
extracting associated text passages from the relevant documents.

3. The method of claim 1, wherein extracting concepts from the relevant documents further comprises:
extracting keywords from the text of the relevant documents; and
compiling a keyword index.

4. The method of claim 3, further comprising:
extracting concepts from the relevant documents using the keyword index.

5. The method of claim 1, wherein the taxonomy is built from the bottom-up.

6. The method of claim 1, wherein the taxonomy is built from the top-down.

7. The method of claim 1, wherein the taxonomy is built via concept clustering.

8. The method of claim 1, wherein building a knowledge base of the extracted concepts further comprises:
creating a default page for the knowledge base.

9. A system for automated knowledge extraction and organization, the system comprising:
means for providing a list of relevant documents resulting from a search of unstructured text information resources;
means for extracting concepts from the relevant documents;
means for organizing the extracted concepts in a taxonomy; and
means for building a knowledge base of the extracted concepts;
wherein the knowledge base is organized based on the taxonomy.

10. The system of claim 9, wherein the means for extracting concepts from the relevant documents further comprises:
means for extracting associated text passages from the relevant documents.

11. The system of claim 9, wherein the means for extracting concepts from the relevant documents further comprises:
means for extracting keywords from the text of the relevant documents; and
means for compiling a keyword index.

12. The system of claim 11, further comprising:
means for extracting concepts from the relevant documents using the keyword index.

15. The system of claim 9, wherein the taxonomy is built via concept clustering.

16. The system of claim 1, wherein the means for building a knowledge base of the extracted concepts further comprises:
means for creating a default page for the knowledge base.

17. A computer program product comprising a computer usable medium having control logic stored therein for causing a computer to automatically extract and organize knowledge, the control logic comprising:
first computer readable program code means for providing a list of relevant documents resulting from a search of unstructured text information resources;
second computer readable program code means for extracting concepts from the relevant documents;
third computer readable program code means for organizing the extracted concepts in a taxonomy; and
fourth computer readable program code means for building a knowledge base of the extracted concepts;
wherein the knowledge base is organized based on the taxonomy.

18. The computer program product of claim 17, wherein the second computer readable program code means for extracting concepts from the relevant documents further comprises:
fifth computer readable program code means for extracting associated text passages from the relevant documents.

19. The computer program product of claim 17, wherein the second computer readable program code means for extracting concepts from the relevant documents further comprises:
sixth computer readable program code means for extracting keywords from the text of the relevant documents; and
seventh computer readable program code means for compiling a keyword index.

20. The computer program product of claim 17, further comprising:
eighth computer readable program code means for extracting concepts from the relevant documents using the keyword index.
